(19) United States
(12) Patent Application Publication
(10) Pub. No.: US 2006/0191907 A1
(43) Pub. Date: Aug. 31, 2006

(54) Welding electrode holder with retractable cable connector

(76) Inventors: Clifton T. Henley, Conroe, TX (US); Neal B. Elmore, Conroe, TX (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 11/347,932

(22) Filed: Feb. 6, 2006

Related U.S. Application Data
(60) Provisional application No. 60/650,488, filed on Feb. 7, 2005.

(51) Int. Cl. B23K 13/01

(52) U.S. Cl. 219/617

(57) ABSTRACT

A welding electrode holder having a pair of jaws for gripping a welding electrode, includes an insulative tubular handle surrounding a proximal region of one of the jaws. An electrical connector, mounted to the distal end of a welding cable, is disposed within the handle for longitudinal movement relative to the proximal region of the jaw, between an advanced position for a mechanical and electrical engagement with the jaw, and a retracted position for separation and electrical isolation from the jaw. The connector is spring biased into the advanced position, and a latching mechanism is mounted to the handle for maintaining the connector retracted against the biasing force. In certain versions, the electrical connector is the proximal connector of a connector pair, and cooperates with a distal connector coupled integrally to the jaw.

This application claims the benefit of priority of Provisional Application No. 60/650,488 entitled “Electrode Holder With Releasable Cabling Coupling,” filed Feb. 7, 2005.

### BACKGROUND OF THE INVENTION

Arc welding is a fusion bonding process in which metals along a joint are melted by locally applying intense heat, then cooled to form a bond. The required heat is produced by an electric arc between the workpiece and an electrode, usually a rod or wire. The electrode is held in a close, spaced-apart relation to the workpiece to form the arc, to conduct current from a power source (AC or DC) to the workpiece via the arc. In many cases, the electrode also melts at the distal tip to supply a filler metal to the bond.

In manual welding operations, the electrode is clamped or otherwise secured into an electrode holder, for example held between a pair of spring-loaded jaws. The jaws are formed of copper alloy or another conductive material, with areas of the jaws covered by insulative material to allow the operator to grasp the holder by hand and control the electrode position by manipulating the holder. Typically the electrode holder incorporates a tubular handle, with an opening sized to receive one end of an electrode cable that conducts current from the power source to the electrode. The cable end is releasably held in the handle by a set screw.

Due to the high electrical currents and voltages (typically several hundred amperes and at least 240 volts) necessary to generate the required arc, the welding electrode and exposed conductive portions of the electrode holder present an electrical shock hazard and may produce unintended arcing from accidental contact with metal objects. As a result, operators are advised not to set a live or “hot” electrode holder on a work area or suspend the holder by hanging the cable, without first disconnecting the cable from the power source. Leaving a connected electrode holder unattended under any circumstances raises the risk that another individual, unaware that the electrode and holder are live, might fail to handle the holder with sufficient care.

Problems encountered in using the electrode and holder include the difficulty in changing electrodes due to the risk of shock or electrocution, especially under wet working conditions. Consumable electrodes may be used up in as little as three minutes, leading to frequent changes. If a problem arises during welding, such as an electrode sticking, it can be difficult to reach the power source to cut the power. In any event, the attempt to turn off the power diverts the operator's attention from the area of the weld in progress. Although the holder jaws may be manipulated to quickly release the electrode and thus cut power to the electrode, the operator loses the ability to control the electrode through the holder, and the holder itself remains live.

### SUMMARY OF THE INVENTION

The present invention has several aspects, each directed to one or more of the following objects. The first of these objects is to provide a welding electrode holder that incorporates structure adapted to positively disconnect the electrode and exposed portions of the electrode holder from an electrical power source.

Another object is to provide a mechanism adapted for connection to a conventional welding electrode holder to enable users to selectively interrupt power to the electrode holder without shutting off the power source.

A further object is to provide a handheld welding device in which power to the device is cut off by a simple, natural movement of a component of the welding device, and in which the power interruption is signaled by a positive tactile sensation.

Yet another object is to provide a welding system in which an electrode holder is operable by hand to selectively and alternatively apply and interrupt power to the electrode.

A first aspect of the invention is a welding apparatus. The welding apparatus includes an electrically conductive welding electrode holding structure adapted to releasably support a welding electrode. A first electrical connector is mechanically and electrically coupled to the electrode holding structure. An electrically insulative handle member integrally supports the first electrical connector. A second electrical connector is mounted for movement relative to the handle, between an advanced position characterized by a surface engagement and electrical coupling of the second electrical connector with the first electrical connector, and a retracted position in which the second electrical connector is disengaged from and electrically isolated from the first electrical connector. A connector controller is mounted between the handle member and the second electrical connector, and is operable to alternatively and selectively locate the second electrical connector in the advanced position and in the retracted position.

By manipulating the connector controller, the welder is able to cut off power to the welding electrode and the electrode holding structure without returning to the power supply. Changing welding electrodes is safer and more convenient, the risk of inadvertent arcing is considerably reduced, and the electrode holding structure can be left unattended without undue risk of electrical shock or damage to the workpiece or welding equipment.

A preferred version of the connector controller comprises a coil spring or other biasing component for urging the second connector into the advanced position, and a releasable latching mechanism. The latching mechanism is movable into a latching position between the handle member and the second electrical connector, to maintain the second connector in the retracted position against the force of the biasing component. To cut power to the welding electrode, the second connector is simply pulled proximally away from the first connector, for example by pulling a welding cable coupled to the connector. When the second connector is pulled to the retracted position, the latching mechanism moves into the latching position, providing a tactile sensation to the welder indicating that the first and second connectors are decoupled.

A second aspect of the present invention is a decoupling mechanism for use with a welding electrode holder. The decoupling mechanism includes an electrically insulative handle. A first electrical connector is secured integrally with respect to the handle. A second electrical connector is mounted with respect to the handle for movement between an advanced position characterized by a surface engagement and electrical coupling thereof with the first electrical connector, and a retracted position in which the second electrical connector is disengaged from and electrically isolated from the first electrical connector. A connector controller is mounted between the handle and the second electrical connector, and is operable to alternatively and selectively locate the second electrical connector in the advanced position and in the retracted position. The first electrical connector includes a coupling segment adapted to be electrically and mechanically coupled to an electrically conductive region of a welding electrode holder.

In preferred versions, the coupling segment of the first electrical connector has a size and shape similar to that of a conductive end region of a welding cable, and is adapted to be releasably coupled to the electrode holder in the same manner as a welding cable. As a result, it is relatively easy to “retrofit” a conventional welding electrode holder to provide control, at or near the electrode holder, of the application and interruption of power to the welding electrode.

Another aspect of the present invention is a welding system. The welding system includes an electrical power supply, and a welding electrode holder comprising an electrically insulative handle. A first electrical connector is mounted integrally to the handle near a distal end thereof. An electrically conductive electrode support structure extends distally from the first connector. A second electrical connector is mounted with respect to the handle for movement relative thereto, between an advanced position characterized by a surface engagement and an electrical coupling thereof with the first connector, and a retracted position in which the second connector is disengaged from and electrically isolated from the first connector. A first electrically conductive component has a distal end connected to the second connector, and a proximal end adapted for coupling to a high voltage terminal of the electrical power supply. The system includes an electrically conductive workpiece clamp. A second electrically conductive component has a distal end coupled to the workpiece clamp, and a proximal end adapted for coupling to a ground terminal of the electrical power supply. A connector controller is adapted to selectively and alternatively maintain the second connector in the advanced and retracted positions.

Thus in accordance with the present invention, welding electrode holders either incorporate or are coupled to components that are operable by hand to selectively and alternatively couple and decouple the electrode holder and electrode with respect to an electrical power supply. The components are convenient to use, removing any incentive to “save time” by changing electrodes while the electrode holder is live, or to leave a live electrode holder unattended, even momentarily. Thus, welding operations proceed with less risk of electrical shock or other injury to operators, and less risk of damage to workpieces, tooling and equipment.

### IN THE DRAWINGS

Further features and advantages will become apparent upon consideration of the following detailed description and drawings, in which:

FIG. 1 is a schematic view of an arc welding system constructed in accordance with the present invention;

FIG. 2 is an elevational view of a welding electrode holder used in the system of FIG. 1;

FIG. 3 is a sectional view of a lower jaw and handle of the electrode holder, illustrating an advanced, closed circuit position of a moveable connector;

FIG. 4 is a perspective view of the moveable connector and a more distal stationary connector;

FIG. 5 is a view similar to that of FIG. 3, illustrating a retracted or open circuit position of the moveable connector;

FIG. 6 is a view similar to that in FIG. 5, showing a lower jaw and handle of an alternative embodiment welding electrode holder;

FIG. 7 is a sectional view showing a handle of a further alternative embodiment welding electrode holder;

FIG. 8 is a sectional view showing a lower jaw and handle of yet another alternative embodiment welding electrode holder, with a moveable connector in the retracted or open circuit position; and

FIG. 9 is a view similar to that of FIG. 8, illustrating the advanced or closed circuit position of the connector.

### DETAILED DESCRIPTION OF THE PREFERRED EMBODIMENTS

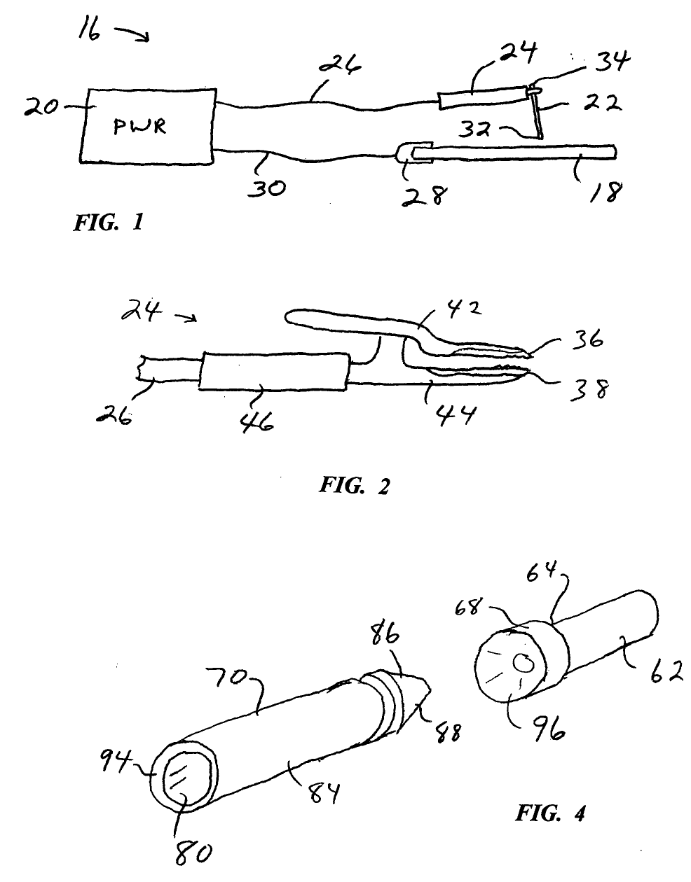

Turning now to the drawings, FIG. 1 shows an arc welding system 16 being used to perform a welding operation on a workpiece 18. The system includes an AC or DC power supply 20, a welding electrode or rod 22, a welding electrode holder 24, a welding cable 26 for electrically coupling the electrode holder to the power supply, an electrically conductive workpiece clamp 28 for holding the workpiece, and a welding cable 30 for electrically coupling the workpiece clamp to the power supply, typically at a ground terminal. Welding electrode 22 has a metal core, and a coating surrounding the core. During welding, the coating provides a gaseous shield around the arc and forms a slag that protects the fresh weld from the air. The metallic core conducts the electrical current necessary to form the arc. In consumable electrodes, the core is formed of a filler metal that melts at a distal tip 32 of the electrode and is carried to the workpiece to form part of the weld.

Electrode holder 24 includes electrically conductive jaws that grip electrode 22 and form an electrical coupling between the electrode and cable 26. With a proximal end 34 of electrode 22 secured within the jaws or other gripping structure of the electrode holder, the operator grips electrode holder 24 by hand to position and guide the electrode during welding, typically maintaining distal tip 32 spaced apart slightly from workpiece 18 to form the arc. The arc is part of an electrical circuit formed by the electrically conductive core of the welding electrode, the conductive portion of electrode holder 24, cable 26, power supply 20, cable 30, workpiece clamp 28 and workpiece 18.

FIG. 2 shows electrode holder 24 in greater detail. The gripping structure includes an upper jaw 36 and a lower jaw 38, preferably formed of a copper-based alloy. The jaws are joined pivotally by a coupling structure 40 that biases the jaws into a closed position against one another, or against a welding electrode disposed between them as shown in FIG. 1, by a spring or other suitable biasing component (not shown). An insulative layer 42, preferably plastic, overlies and partially surrounds the upper jaw, and extends proximally away from the upper jaw to provide an insulative region that can be gripped by the operator during welding and between welding operations, e.g. to change electrodes. An insulative layer 44 overlies and partially surrounds lower jaw 38. The proximal part of the structure providing lower jaw 38 is surrounded by a tubular, electrically insulative handle 46, preferably plastic.

To load welding electrode 22 into electrode holder 24, the operator grips handle 46 and insulative layer 42, squeezes to move these components toward each other to open the jaws, inserts proximal end 34 between the jaws, then releases the grip to allow the jaws to close about the electrode.

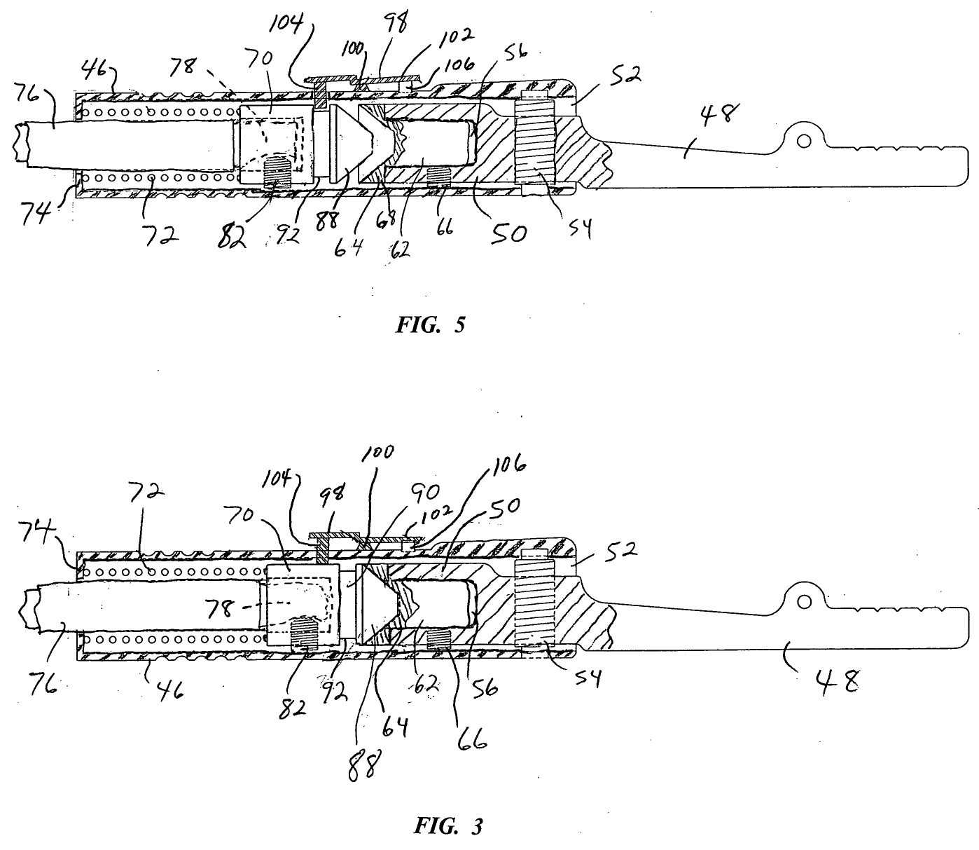

As seen in FIG. 3, lower jaw 38 is formed along the distal region of an electrically conductive lower jaw frame member 48. A proximal region 50 of frame member 48 is disposed within an opening 52 through handle 46, held in place by a set screw 54. A socket 56 is formed in proximal region 50, open at the proximal end of frame member 48. Socket 56 is adapted to receive a cylindrical shank 62 of a distal electrical connector 64. Distal connector 64 is releasably coupled to frame member 48 by a set screw 66. An enlarged head 68 of connector 64 abuts the proximal end of frame member 48.

Also contained within opening 52 is a proximal connector 70, shown in FIG. 3 in an advanced, circuit-closing position, electrically and mechanically engaged with distal connector 64. Proximal connector 70 is maintained in the advanced position by a coil spring 72, held under compression between connector 70 and a proximal wall 74 of handle 46. An opening through proximal wall 74 accommodates welding cable 26. Along a distal end region of cable 26, an electrically insulative jacket 76 is removed to provide an electrically conductive distal tip 78, which is removably secured within a socket 80 of proximal connector 70 by a set screw 82. If desired, a short welding cable can be secured to connector 70 either with screw 82 or permanently, and equipped with a proximal end coupler for convenient connections and disconnections with welding cables outside of handle 46.

The structure and interaction of connectors 64 and 70 is perhaps best understood from FIG. 4. Proximal connector 70 includes a cylindrical body 84 and a distal head 86 shaped to provide a truncated-conical male contact surface 88. A neck 90 between the body and head (FIG. 3) forms an annular, circumferential groove 92 in connector 70. The proximal end of connector 70 includes an annular shoulder 94 formed around socket 80.

A depression, formed in head 68 of the distal connector and extending distally into shank 62, provides a truncated-conical contact surface 96 that converges in the distal direction. Thus, when moved distally into engagement with distal connector 64, proximal connector 70 tends to center itself relative to the distal connector and form a nesting engagement with the distal connector with contact surfaces 88 and 96 contiguous, as shown in FIG. 3.

Proximal connector 70 is moveable axially (longitudinally) relative to the handle. FIG. 3 shows connector 70 in a distal or advanced position, engaged with distal connector 64 to complete the circuit described above in connection with FIG. 1. Coil spring 72 urges connector 70 into the advanced position. To open the circuit, connector 70 is moved proximally away from connector 64, against the spring force. With cable 26 coupled to the proximal connector, connector 70 is moved by pulling the cable in the proximal direction relative to handle 46 until the connector reaches a retracted position shown in FIG. 5. This opens the circuit, cutting off power to frame member 48.

To maintain an open circuit, proximal connector 70 is held in the retracted position against the force of spring 72. To this end, a latching mechanism 98 is mounted to handle 46. Mechanism 98 includes a pivot support 100 integral with the handle, a rocker arm 102 mounted to pivot relative to support 100, a latching pin 104 extending downwardly from the rocker arm, and a spring 106 between the rocker arm and handle 46. Spring 106 urges the rocker arm to rotate counterclockwise as viewed in FIGS. 3 and 5, thus to bias latching pin 104 downwardly. In FIG. 5, pin 104 is shown in the latching position, extended through an aperture in handle 46 and into groove 92, thus to hold proximal connector 70 in the retracted position against the force of coil spring 72.

With connectors 64 and 70 spaced apart, the circuit is open, and neither electrode holder 24 nor electrode 22 is live. The operator can handle the electrode and the exposed electrically conductive regions of the electrode holder without the risk of an electrical shock, and the electrode/holder assembly can be set down on a working surface without risking accidental arcing. Nonetheless, welding cable 26 remains mechanically coupled to the electrode holder through handle 46, and the operator is able to selectively position the electrode holder and electrode to commence a welding operation. Such positioning is facilitated by the circular profile of neck 90, which allows the operator to rotate handle 46 (and thus the electrode holder) relative to welding cable 26 when connector 70 is retracted.

When ready to begin a weld, the operator presses rocker arm 102 on its distal end near spring 106, rotating the rocker arm clockwise as viewed in FIG. 5 to compress the spring and carry latching pin 104 transversely away from connector 70, upwardly as viewed in the figure. With the latching pin free of the groove, proximal connector 70 responds to the force of spring 72 and moves axially toward distal connector 64 until contact surfaces 88 and 96 nestingly engage. This closes the circuit and permits the operator to begin the weld.

Due to the truncated-conical shapes of the contact surfaces, connectors 64 and 70 while engaged remain free to rotate relative to one another about a longitudinal axis. The relative rotation counteracts any tendency in welding cable 26 to twist as the electrode holder is maneuvered, and allows for a wiping action between contact surfaces 88 and 96, tending to keep these surfaces cleaner for a more reliable electrical connection.

When the welding operation is complete, the operator can cut off power to the holder and electrode, simply by pulling welding cable 26 proximally relative to handle 46. This moves connector 70 in the proximal direction away from connector 64, and moves groove 92 toward latching pin 104. As the groove and latching pin become aligned, the pin is carried into the groove by virtue of rocker arm 102 responding to the force of spring 106. In the latching position, pin 106 prevents proximal connector 70 from returning to the advanced position. In addition, head 86 of the proximal connector is positioned to engage pin 106 in response to any further proximal movement of connector 70, to prevent any further retraction of the proximal connector. In short, the latching pin essentially locks proximal connector 70 in the retracted position, giving the operator a definite tactile signal that connector 70 is retracted and the circuit is open. Retraction also is signaled visually, by the angular position of rocker arm 102. Typically, the tactile indication is more useful during welding, while the visual indication is useful when encountering an electrode holder left unattended.

Sockets 56 and 80 are substantially the same in diameter, as are shank 62 and cable distal tip 78. Thus, a conventional electrode holder with a socket intended for a welding cable can be augmented with connectors 64 and 70. The handle of the conventional holder may not have a proximal wall like wall 74, in which case the handle is modified or replaced to insure that spring 72 is retained.

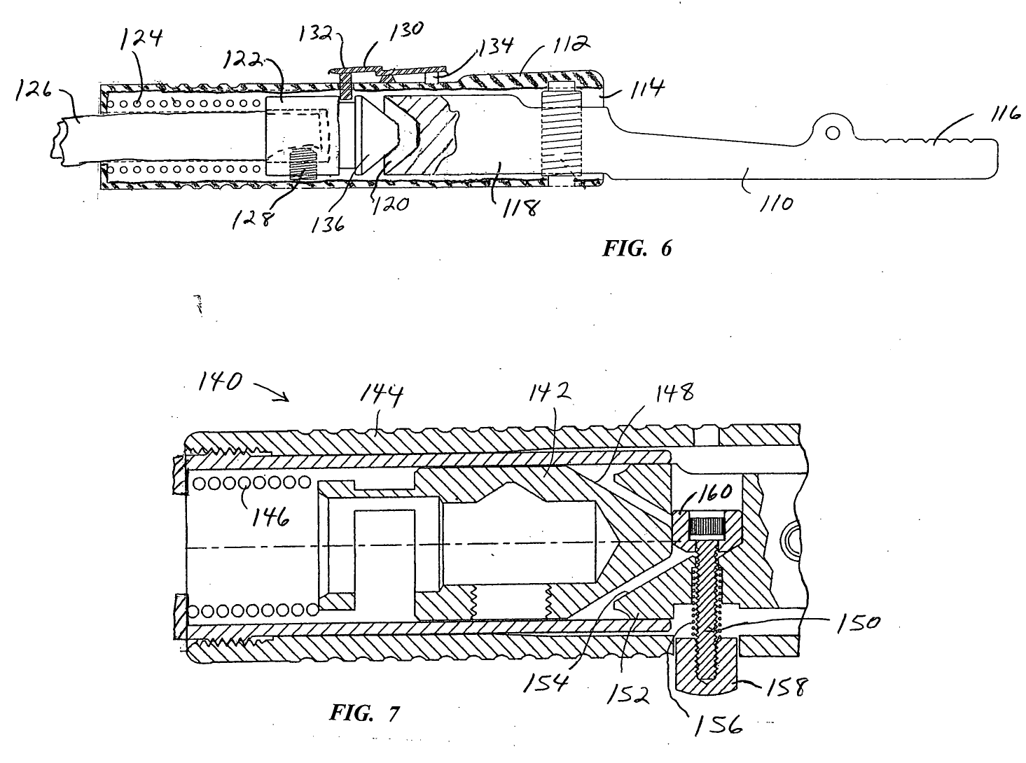

FIG. 6 is a sectional view similar to that in FIG. 5, showing a portion of an alternative embodiment electrode holder, in particular a lower jaw frame member 110 mounted to a tubular handle 112 within an opening 114 through the handle. Handle 112 is substantially identical to handle 46. Frame member 110 is similar to frame member 48 in the sense of incorporating a lower jaw 116 along its exposed distal region. In contrast to frame member 48, a proximal end region 118 of frame member 110 is provided with a depression open to the proximal end to provide a truncated-conical contact surface 120. Thus, a frame member and connector are replaced with a single, unitary component. With the contact surface built in to frame member 110 in this manner, there is no need for a connector similar to distal connector 64.

A connector 122 is mounted for longitudinal movement within opening 114, biased in the distal direction by a coil spring 124 under compression. A welding cable 126 is secured to connector 122 by a set screw 128. As before, connector 122 can be moved proximally against the force of spring 124 by pulling cable 126 proximally relative to handle 112. Connector 122, spring 124 and cable 126 are substantially identical to their counterparts in electrode holder 24.

A latching mechanism 130, substantially the same as mechanism 98, is operable as before, by alternatively pulling cable 126 and by pressing a rocker arm to compress a spring 134, to selectively and alternatively place connector 122 in the retracted position as shown, and in the advanced position in which a contact surface 136 of connector 122 nestingly engages contact surface 120 of frame member 110.

FIG. 7 shows part of an alternative embodiment electrode holder 140 in which a proximal connector 142 is disposed moveably within a handle 144, biased in the distal direction by a compressed coil spring 146. Connector 142 has a convex, truncated-conical contact surface 148 at its distal end. Connector 142 is maintained in a proximal retracted position by a plunger 150 mounted to reciprocate relative to handle 144 in a transverse direction, vertically as viewed in the figure. A distal connector 152, shown longitudinally spaced apart from connector 140, has a concave truncated-conical contact surface 154 at its proximal end. Plunger 150 is biased into an open position as shown, by a coil spring 156 under compression between connector 152 and a button 158 at the radially outward end of the plunger. With plunger 150 positioned as shown, a head 160 of the plunger prevents proximal connector 142 from moving distally. When ready to begin welding, the operator presses button 158 to move plunger 150 upwardly. Upward movement of plunger head 160 releases connector 142 for distal travel responsive to the force of coil spring 146, causing contact surfaces 148 and 154 to nestingly engage, closing the circuit.

As before, power to distal connector 152 and the electrode can be cut off by pulling a welding cable proximally relative to handle 144. This moves proximal connector 142 away from distal connector 152 and plunger head 160, allowing plunger 150 to return to the open-circuit position under the force of spring 156.

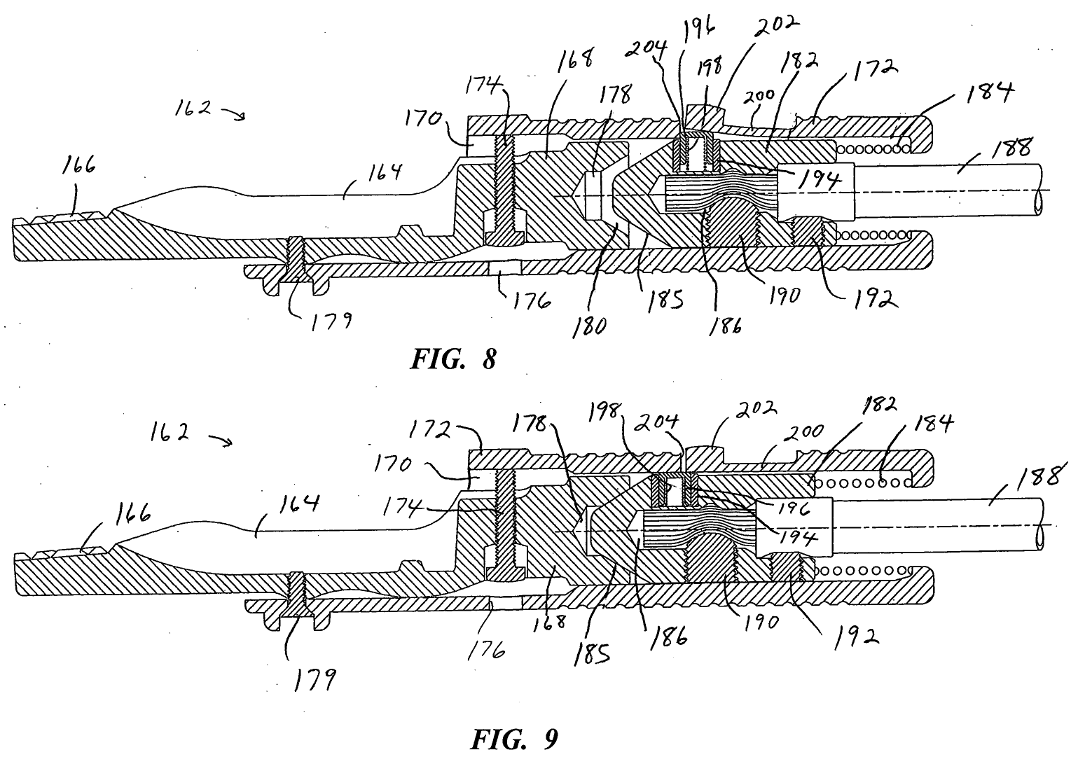

FIGS. 8 and 9 show part of another alternative embodiment welding electrode holder 162. A lower jaw frame member 164 includes a lower jaw 166 along its distal end region. A proximal end region 168 of the frame member is secured within an opening 170 of an insulative handle 172 by a screw 174. An opening 176 through the handle provides access to the screw. A depression 178 is formed into the proximal end region to provide a truncated-conical female contact surface 180. A more distal screw 179 also secures the frame member.

A connector 182 is contained within opening 170 for longitudinal movement relative to the handle, biased in the distal direction by a coil spring 184 under compression. The connector has a truncated-conical male contact surface 185. Connector 182 includes a longitudinally extended socket 186 to accommodate the distal end of a welding cable 188. Screws 190 and 192 secure the welding cable to connector 182, so that the connector can be moved proximally against the spring force by pulling the welding cable.

A radial bore into connector 182 accommodates a collar 194, a cap 196 surrounded by the collar, and a coil spring 198 surrounded by the cap. Cap 196 is slideable transversely relative to the collar, and spring 198 biases the cap upwardly as viewed in the figures.

A portion of handle 172 is cut and shaped to provide a cantilevered flexure 200 enlarged at its free end to provide a button 202. In a relaxed state, i.e. when subject to no external forces, flexure 200 lies essentially flat as shown in FIG. 9. Under the force of spring 198 acting through cap 196, flexure 200 is elastically bent to raise button 202 as seen in FIG. 8.

As shown in FIG. 8, cap 196 is positionable transversely outwardly of connector 182, and abuts a shoulder 204 of the handle to maintain connector 182 in the retracted position against the force of spring 184. To close the circuit, the operator presses button 202, which moves cap 196 inwardly while compressing spring 198. When the cap travels inwardly a distance sufficient to clear shoulder 204, connector 182 is free to move distally under the force of spring 184, until male contact surface 185 engages female contact surface 180. This locates connector 182 in the advanced position, as shown in FIG. 9. A portion of handle 172 near shoulder 204 overlies cap 196, maintaining an inward position of the cap against the force of spring 198.

To retract connector 182, welding cable 188 is pulled proximally relative to the handle. When movement of the connector is sufficient to carry cap 196 proximally of shoulder 204, the cap moves transversely upward under the force of spring 198, again to maintain connector 182 in the retracted position against the force of spring 184.

In each of the preceding embodiments, a connector is mounted for a movement within the tubular handle of an electrode holder, between advanced and retracted positions for respectively applying and interrupting power to the electrode and jaws of the electrode holder. The moveable connector affords convenient control over the state of the electrode, motivating users to cut off power when changing electrodes or when leaving the electrode holder unattended, even momentarily. Down time occasioned by the need to change electrodes is reduced. In several embodiments, handling of the electrode holder is facilitated by a connector construction that permits rotation of the electrode holder relative to the moveable connector and attached welding cable, regardless of whether the connector is advanced or retracted. In all embodiments the risk of electrical shock occasioned by changing electrodes or leaving an electrode holder unattended, is reduced. All embodiments provide a clear tactile sensation to inform an operator when power to the electrode is cut off. It is apparent that the principals of the invention may be applied to other environments, whether or not related to welding, to enable the operator to conveniently interrupt power to a working end of a tool or system without returning to a remote power supply.

What is claimed is:

1. A welding apparatus, including:
an electrically conductive welding electrode holding structure adapted to releasably support a welding electrode;
a first electrical connector disposed at a proximal end region of the electrode holding structure;
an electrically insulative handle member mounted to the electrode holding structure and integral with first electrical connector;
a second electrical connector mounted for movement relative to the handle between an advanced position characterized by a surface engagement and electrical coupling of the second electrical connector with the first electrical connector, and a retracted position in which the second electrical connector is disengaged from and electrically isolated from the first electrical connector; and
a connector controller mounted between the handle member and the second electrical connector, operable to alternatively and selectively locate the second electrical connector in the advanced position and in the retracted position.

2. The apparatus of claim 1 wherein:
the first electrical connector is formed as part of the electrode holding structure.

3. The apparatus of claim 2 wherein:
the electrode holding structure comprises first and second jaws mounted movably relative to one another between open and closed positions, and the first jaw and the first electrical connector are formed as a unitary member.

4. the apparatus of claim 2 wherein:
the first electrical connector is removably coupled to the electrode holding structure.

5. The apparatus of claim 1 further including:
a welding cable attached to the second electrical connector.

6. The apparatus of claim 1 wherein:
the handle member surrounds the first and second electrical connectors.

7. The apparatus of claim 1 wherein:
the first electrical connector has a truncated conical first surface, and the second electrical connector has a truncated conical second surface substantially conforming to the first surface and contiguous with the first surface when the first and second electrical connectors are in said surface engagement.

8. The apparatus of claim 7 wherein:
the first and second surfaces converge in a direction from the second electrical connector toward the first electrical connector.

9. The apparatus of claim 1 wherein:
the connector controller comprises a biasing component disposed between the second electrical connector and the handle member for urging the second connector toward the advanced position.

10. The apparatus of claim 9 wherein:
the biasing component comprises a coil spring.

11. The apparatus of claim 9 wherein:
the connector controller further comprises a releasable latching mechanism movable into a latching position between the handle member and the second electrical connector to maintain the second connector in the retracted position against the force of the biasing component.

12. The apparatus of claim 10 wherein:
the latching mechanism comprises a latching member, a rocker arm supporting the latching member and mounted pivotally with respect to the handle member, and a spring for biasing the rocker arm toward the latching position.

13. The apparatus of claim 1 further including:
an electrically conductive first cable coupled to the second electrical connector and adapted to electrically couple the second connector to a high voltage terminal of an electrical power supply.

14. The apparatus of claim 13 wherein:
the electrically conductive first cable is removably secured to the second electrical connector.

15. The apparatus of claim 14 further including:
an electrically conductive second cable having a first end adapted for an electrical coupling to a ground terminal of the power supply, and a workpiece clamp coupled to a second and opposite end of the second welding cable.

16. A decoupling mechanism for use with a welding electrode holder, including:
an electrically insulative handle, a first electrical connector secured integrally with respect to the handle, and a second electrical connector mounted with respect to the handle for movement between an advanced position characterized by a surface engagement and electrical coupling thereof with the first electrical connector, and a retracted position in which the second electrical connector is disengaged from and electrically isolated from the first electrical connector; and
a connector controller mounted between the handle and the second electrical connector, operable to alternatively and selectively locate the second electrical connector in the advanced position and in the retracted position;
wherein the first electrical connector includes a coupling segment adapted to be electrically and mechanically coupled to an electrically conductive region of a welding electrode holder.

17. The mechanism of claim 16 wherein:
the coupling segment is adapted to be so secured to a jaw of a welding electrode holder having a pair of opposed, pivotally coupled jaws.

18. The mechanism of claim 16 wherein:
the handle is tubular and substantially surrounds the first and second electrical connectors.

19. The mechanism of claim 16 wherein:
the first electrical connector has a truncated conical first surface, and the second electrical connector has a truncated conical second surface substantially conforming to the first surface and contiguous with the first surface when the first and second electrical connectors are in said surface engagement.

20. The mechanism of claim 19 wherein:
the first and second surfaces converge in a direction from the second electrical connector toward the first electrical connector.

21. The mechanism of claim 16 wherein:
the connector controller comprises a biasing component disposed between the second electrical connector and the handle for urging the second connector toward the advanced position.

22. The mechanism of claim 16 further including:
an electrically conductive cable coupled to the second electrical connector.

23. The mechanism of claim 22 further including:
the connector controller further comprises a releasable latching mechanism movable into a latching position between the handle member and the second electrical connector to maintain the second connector in the retracted position against the force of the biasing component.

24. The mechanism of claim 23 wherein:
the latching mechanism comprises a latching member, a rocker arm supporting the latching member and mounted pivotably with respect to the handle member, and a spring for biasing the rocker arm toward the latching position.

25. The mechanism of claim 23 further including:
an electrically conductive component coupled to the second electrical connector and adapted to electrically couple the second connector to an electrical power supply.

26. The mechanism of claim 16 further including:
a welding cable attached to the second electrical connector.

27. A welding system including:
an electrical power supply;
a welding electrode holder comprising an electrically insulative handle, a first electrical connector mounted integrally to the handle near a distal end thereof, an electrically conductive electrode support structure extending distally from the first connector, and a second electrical connector mounted with respect to the handle for movement relative thereto between an advanced position characterized by a surface engagement and an electrical coupling thereof with the first connector, and a retracted position in which the second connector is disengaged from and electrically isolated from the first connector;
a first electrically conductive component having a distal end connected to the second connector and a proximal end adapted for coupling to a high voltage terminal of the electrical power supply;
an electrically conductive workpiece clamp; and
a second electrically conductive component having a distal end coupled to the workpiece clamp and a proximal end adapted for coupling to a ground terminal of the electrical power supply; and
a connector controller adapted to selectively and alternatively maintain the second connector in the advanced and retracted positions.

28. The system of claim 27 wherein:
the connector controller comprises a biasing component disposed between the handle and the second electrical connector for urging the second connector toward the advanced position, and a latching mechanism for maintaining the second connector in the retracted position against the force of the biasing component.

29. The system of claim 28 wherein:
the latching mechanism comprises a latching member, a rocker arm supporting the latching member and mounted pivotably with respect to the handle member, and a spring for biasing the rocker arm toward the latching position.

30. The system of claim 27 wherein:
the first and second electrically conductive components comprise respective first and second welding cables.

31. The system of claim 27 wherein:
the first electrical connector is integrally coupled to the electrode holding structure.

32. The system of claim 27 further including:
a fastener for removably securing the first electrical connector to the handle.

33. The system of claim 27 wherein:
the handle surrounds the first and second electrical connectors.

34. The system of claim 27 wherein:
the first and second electrical connectors have respective first and second surfaces adapted to contact one another during said surface engagement, and at least one of the first and second surfaces has a truncated conical shape.

35. The system of claim 27 further including:
means for removably coupling the second electrical connector and the distal end of the first electrically conductive component.
